(19) United States
(12) Patent Application Publication
(10) Pub. No.: US 2004/0042875 A1
(43) Pub. Date: Mar. 4, 2004

(54) Screw strip with flanges at two sides

(76) Inventor: Shu-Chung Huang, Taipei (TW)

Correspondence Address: Shu-Chung Huang, 235 Chung-Ho, Box 8-24, Taipei, TW

(21) Appl. No.: 10/233,351

(22) Filed: Sep. 3, 2002

(51) Int. Cl. F16B 15/08

(52) U.S. Cl. 411/442

(57) ABSTRACT

A screw strip is a long strip and has a plurality of receiving holes for receiving a plurality of screws. A periphery of each receiving hole has a plurality of radiated long slits. Two sides of the screw strip have a plurality of slots for pushing a nail gun therethrough. Each of two sides of the screw strip has a plurality of flanges which is matched to the transfer guide groove of a nail gun. By the flanges, when the screw strip passes through the transfer guide groove of a nail gun, it can be positioned so as to prevent the screw strip bends and deforms as the screws pass through the strip.

### FIELD OF THE INVENTION

The present invention relates to screw strips, and particularly to a screw strip with flanges at two sides. By the flanges, when the screw strip passes through the transfer guide groove of a nail gun, it can be positioned so as to prevent the screw strip bends and deforms as the screws passes through the strip.

### BACKGROUND OF THE INVENTION

Nail guns are used to inject screws. Referring to FIGS. 1 to 4, a prior art screw strip 10 is a long strip injected from a plastic material. The screw strip 10 has a plurality of receiving holes 11 for receiving a plurality of screws 20.

An outer side of each receiving hole 11 has a plurality of radiated long slits 12. Two sides of the screw strip 10 have a plurality of slots 13 for pushing a nail gun 30 therethrough (referring to FIG. 1). The screw strip 40 is placed to pass through the transfer guide groove 31 of the nail gun 30 for transferring screws automatically (referring to FIGS. 2 and 3). Thereby, the screw strip 40 has the function of transferring screws 20. However, the prior art screw strip 10 is a thin piece (referring to FIG. 3). When the prior art screw strip 10 is placed in the transfer guide groove 31 of the nail gun 30, if the screw 20 damages the screw strip 10, the screw strip 40 will bend forwards (referring to FIG. 4) so that two sides of the screw strip 10 are separated from the transfer guide groove 31 of the nail gun 30. As a result, the screw strip is buckled in the transfer guide groove and thus can not be used continuously.

### SUMMARY OF THE INVENTION

Accordingly, the primary object of the present invention is to provide a screw strip which is a long strip and has a plurality of receiving holes for receiving a plurality of screws. A periphery of each receiving hole has a plurality of radiated long slits. Two sides of the screw strip have a plurality of slots for pushing a nail gun therethrough. Each of two sides of the screw strip has a plurality of flanges which is matched to the transfer guide groove of a nail gun. By the flanges, when the screw strip passes through the transfer guide groove of a nail gun, it can be positioned so as to prevent the screw strip bends and deforms as the screws pass through the strip.

The various objects and advantages of the present invention will be more readily understood from the following detailed description when read in conjunction with the appended drawing.

### BRIEF DESCRIPTION OF THE DRAWINGS

FIG. 1 is a perspective view of a prior art screw strip.

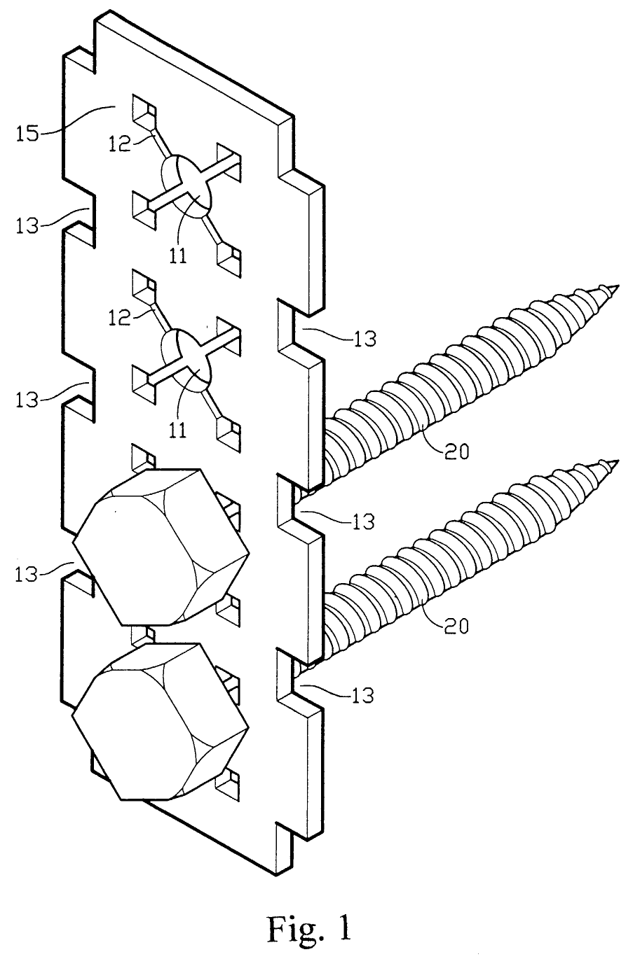

FIG. 2 is a lateral view showing a prior art screw strip which is used to a nail gun.

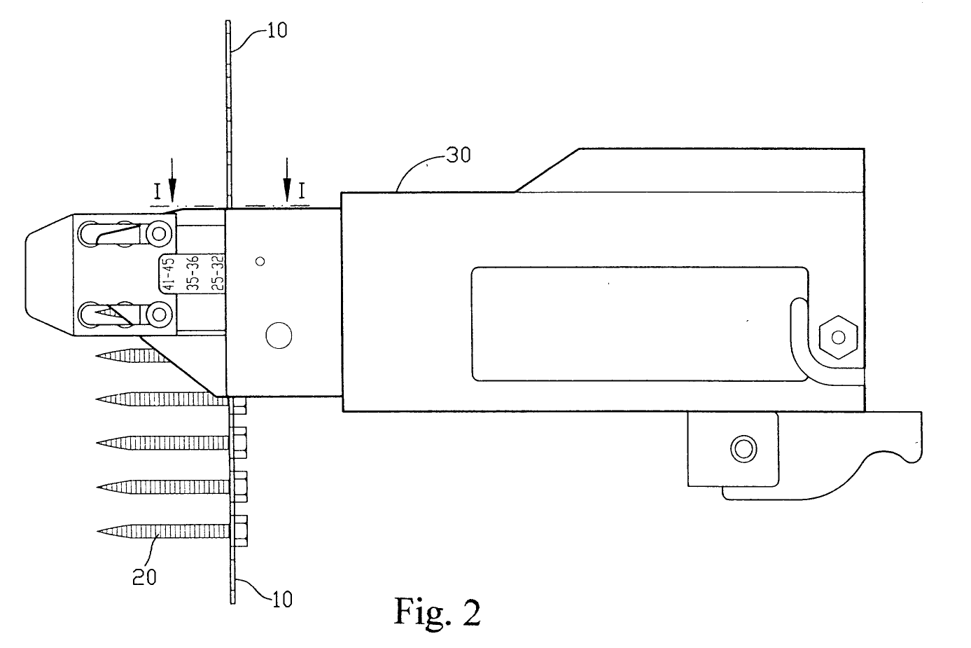

FIG. 3 is a lateral view along I-I of FIG. 2.

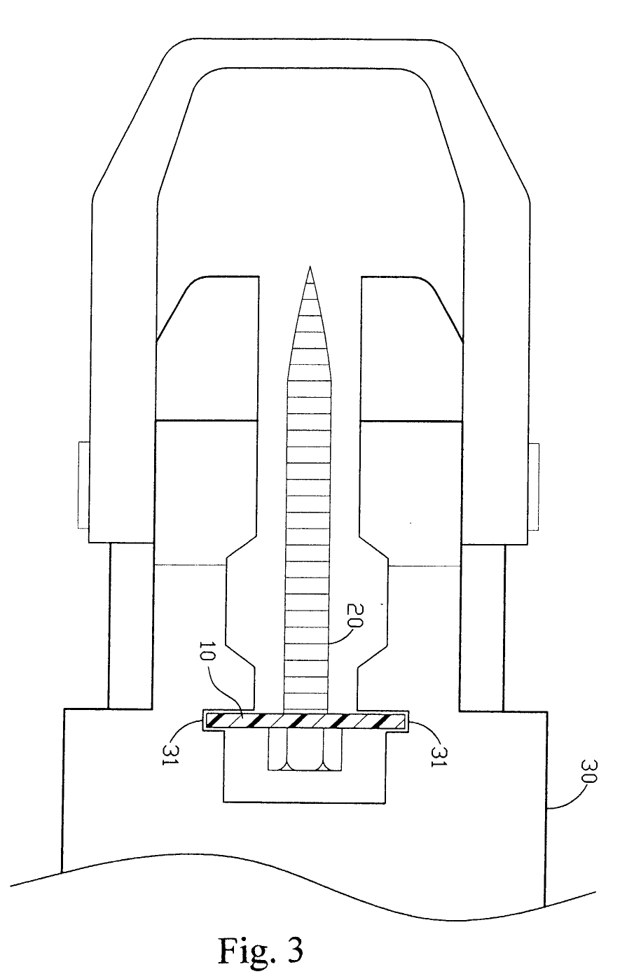

FIG. 4 is a schematic view showing that a prior art screw strip is bent forwards since the strip is worn out by screws.

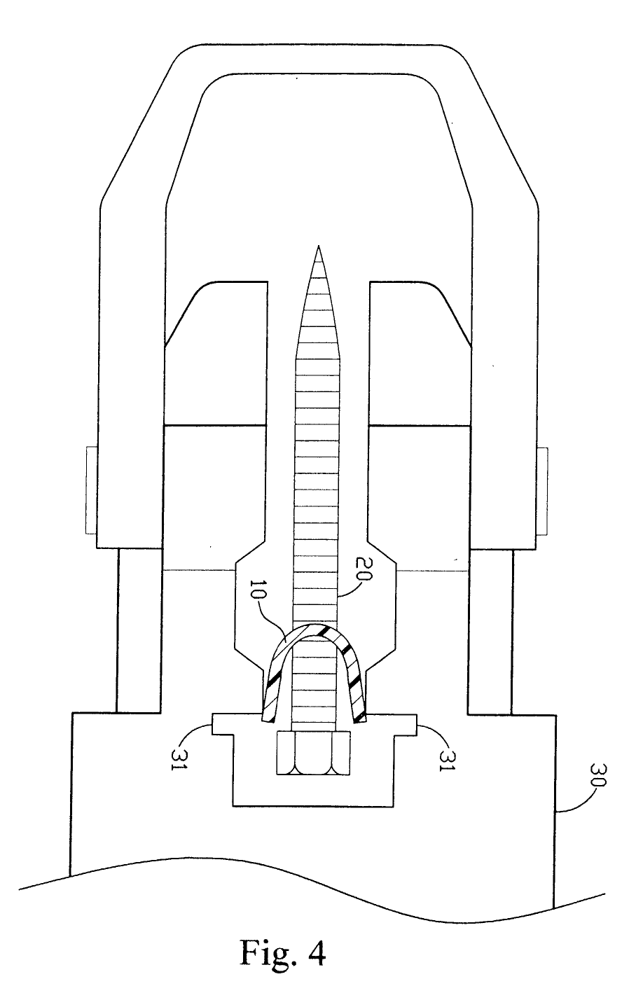

FIG. 5 is an exploded perspective view of the present invention.

FIG. 6 is a lateral view showing that the screw strip of the present invention is used with a nail gun.

FIG. 7 is a cross sectional view along II-II of FIG. 6.

FIG. 8 shows one embodiment of the flange of the present invention.

FIG. 9 shows another embodiment of the flange of the present invention.

### DETAILED DESCRIPTION OF THE PREFERRED EMBODIMENTS

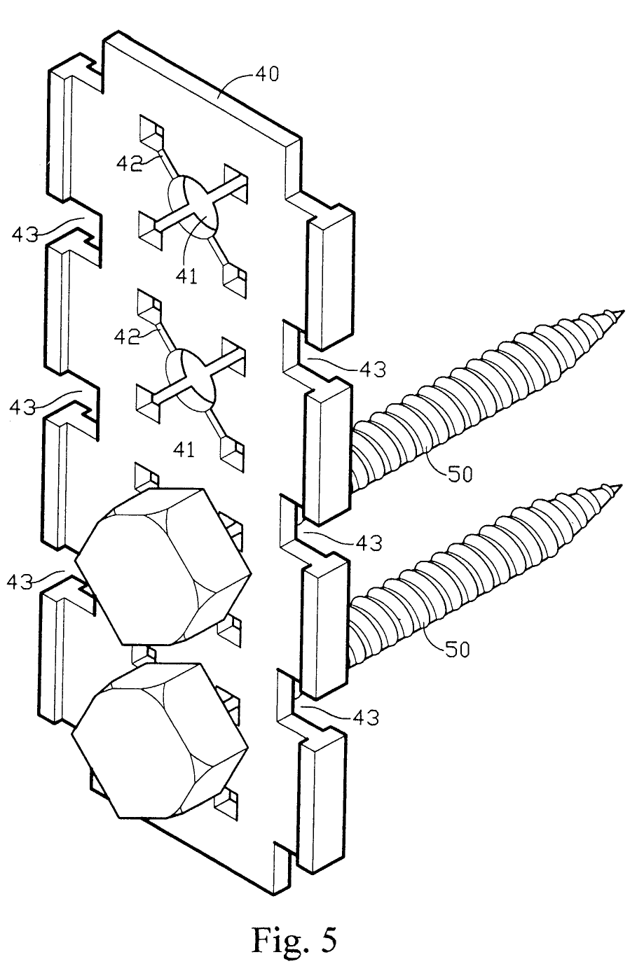

Referring to FIG. 5, the perspective view of the screw strip 40 according to the present invention is illustrated. In the present invention, the screw strip 40 is a long strip injected from a plastic material. The screw strip 40 has a plurality of receiving holes 41 for receiving a plurality of screws 50.

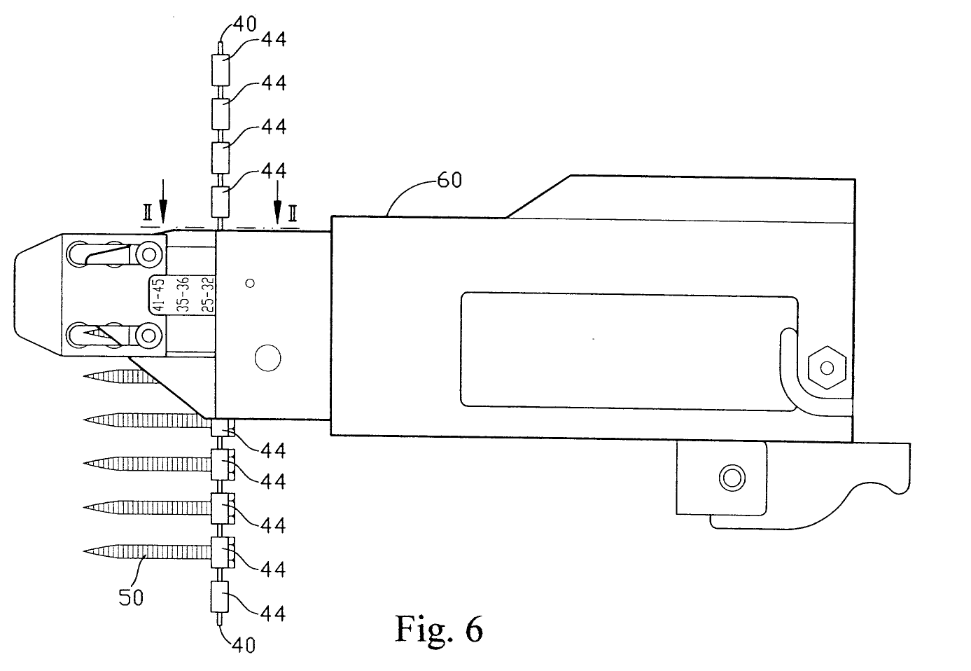

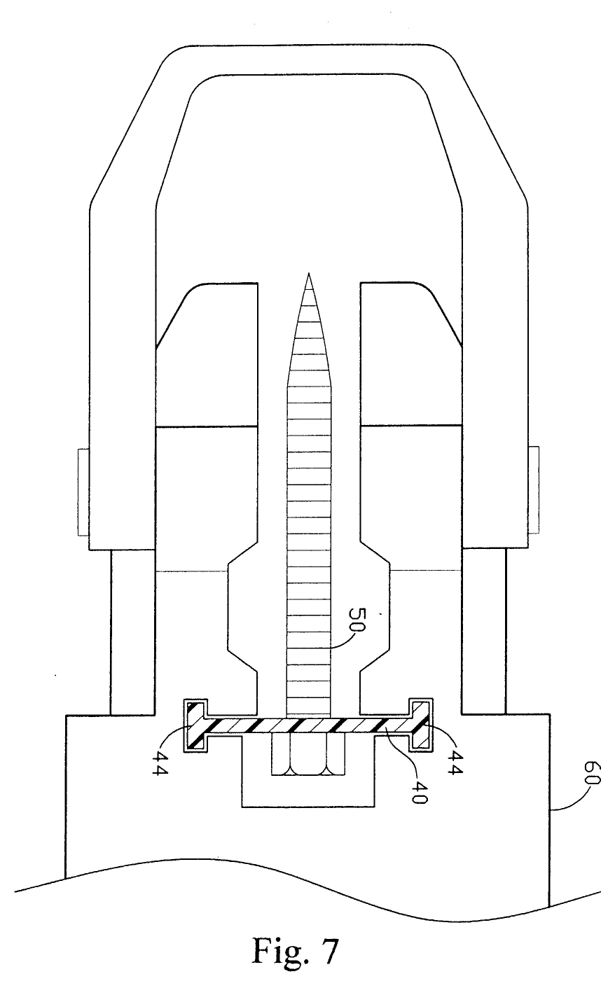

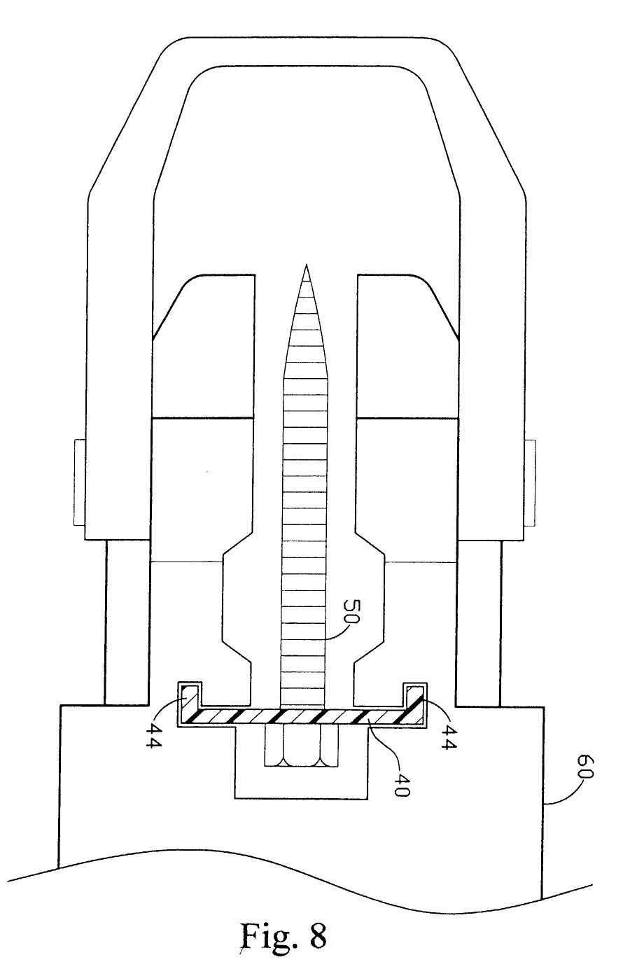

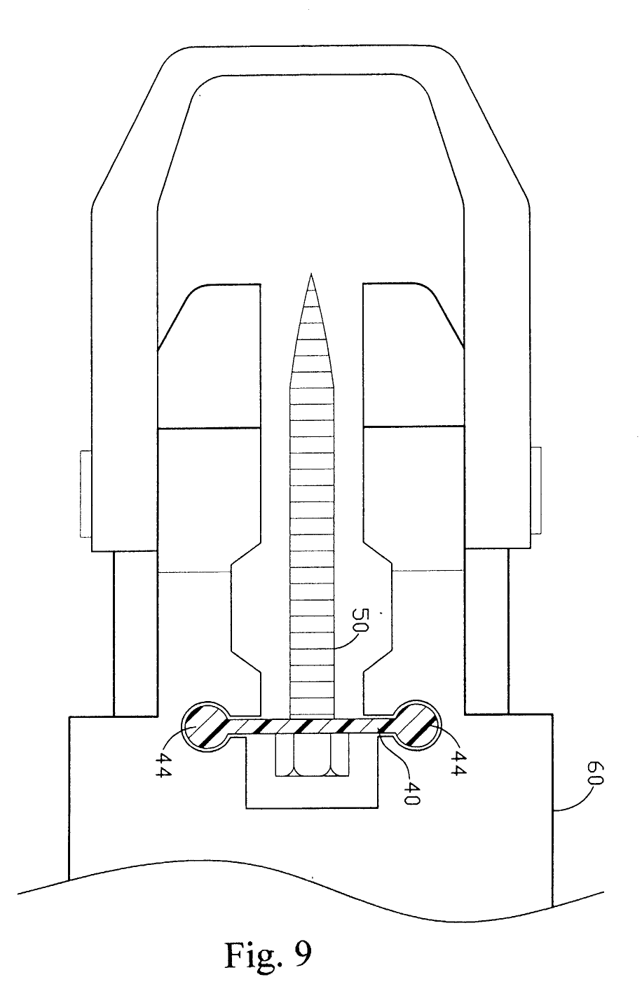

An outer side of each receiving hole 41 has a plurality of radiated long slits 42. Two sides of the screw strip 40 have a plurality of slots 43 for pushing a nail gun 60 therethrough. Each of two sides of the screw strip 40 has flanges 44 so that viewing from the lateral sides, the screw strip 40 is illustrated as a T shape (referring to FIGS. 6 and 7) or an L shape (referring to FIG. 8). A cross section of the flange 44 can be a rectangular shape (referring to FIG. 7) or a round shape (referring to FIG. 9) or other shapes. Thereby, by the flanges 44, when the screw strip 40 passes through the transfer guide groove 61 of a nail gun 60, it can be positioned so as to prevent the screw strip 40 bends and deforms as the screws 50 passes through the strip.

It is appreciated from above description that in the present invention, the two sides of the screw strip 40 are installed with a plurality of flanges 44, and the transfer guide groove 61 of the nail gun 60 are made to match the flanges 44. When the screw strip 40 passes through the transfer guide groove 61 of a nail gun 60, it can be positioned so as to prevent the screw strip 40 bends and deforms as the screws 50 passes through the strip. Thereby, the user can operate easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A screw strip being a long strip and having a plurality of receiving holes for receiving a plurality of screws; a periphery of each receiving hole having a plurality of radiated long slits; two sides of the screw strip having a plurality of slots for pushing a nail gun therethrough; characterized in that:
each of two sides of the screw strip has a plurality of flanges which is located between two adjacent slots and matched to a transfer guide groove of a nail gun;
whereby, by the flanges, when the screw strip passes through the transfer guide groove of a nail gun, it is positioned so as to prevent the screw strip bends and deforms.

2. The screw strip as claimed in claim 1, wherein a cross section of the flange has a shape selected from one of a group containing rectangular shapes and a round shape.
